(19) United States
(12) Patent Application Publication
(10) Pub. No.: US 2015/0011921 A1
(43) Pub. Date: Jan. 8, 2015

(54) DEVICE FOR TRIGGER POINT THERAPY, MYOFASCIAL RELEASE, AND SELF MASSAGE

(71) Applicant: Jaspinder Sidhu, Oakville (CA)

(72) Inventor: Jaspinder Sidhu, Oakville (CA)

(21) Appl. No.: 14/321,965

(22) Filed: Jul. 2, 2014

Related U.S. Application Data
(60) Provisional application No. 61/842,682, filed on Jul. 3, 2013.

(51) Int. Cl. A61H 1/00

(52) U.S. Cl. CPC A61H 1/008
USPC 601/134

(57) ABSTRACT

It is one aspect to provide a novel trigger point therapy device which is effective for pain management with the treatment of trigger points, releasing tight and painful myofascial fascia, and general self massage. In preferred embodiments, the apparatus comprises: a flexible strap; a first knob mounted to the strap and protruding out from a side of the strap; a second knob mounted proximate to the first knob and protruding out from the side of the strap in the same direction as the first knob; and a strap adjustment means; and wherein the device is configured so that a user may apply varying degrees of pressure to tight and painful myofascial fascia providing hands free self massage.

### CROSS REFERENCES TO RELATED APPLICATION

The present application claims priority to, co-pending U.S. provisional patent application No. 61/842,682 filed Jul. 3, 2013, and entitled “DEVICE FOR TRIGGER POINT THERAPY, MYOFASCIAL RELEASE AND SELF MASSAGE” the entire contents of the above-referenced patent application is incorporated by reference herein.

### FIELD OF THE INVENTION

The present invention is in the technical field of self massage therapy. More particularly, the present invention is in the field of self trigger point therapy and myofascial release.

### BACKGROUND

Myofascial pain, identified by trigger points and tight myofascial fascia, is the most common cause of muscle aches and pain. Studies estimate that in 75 to 90% of cases, myofascial pain is a primary cause of regional pain. Current treatment is applied through various health professionals and techniques. Health professionals involved in the treatment of trigger points includes, but not limited to, physicians, chiropractors, physical therapists and massage therapists. Trigger points are treated via pressure, either directed through the hands or various tools. Some health professionals recommend applying pressure to trigger points several times a day.

Trigger points are generally applied through variable pressure. Apply light pressure and you may not effectively treat the trigger point. Apply pressure too hard and muscle soreness and pain can result. Current trigger point devices are either utilized via pressure by the various body parts of health professionals, or through tools. Most of these tools are either placed on the floor or against a wall, with the weight of the body generating the applied pressure. These types of tools don't take into consideration the ability to apply a varying degree of pressure to the trigger point. Other devices can be hand held by the person, applying pressure to the trigger point by pushing or pulling the device with their own hands. All the devices and techniques mentioned don't allow for a gradual increase and decrease in trigger point pressure without using the arms or hands. These positions place the body in a tensed position, decreasing the effectiveness of the treatment.

Myofascial release is the process of applying pressure to areas of pain and tenderness called fascia through health practitioners' elbows, knuckles, or external tools. The tender area is compressed with a practitioner's body part or an external tool while the muscle is put in a stretched position. The external tools are mostly held by the hands and limit the ability to relax the upper body and prevent a person with tender fascial areas to initiate a gentle stretch.

Some trigger point devices are available that have balls or rollers on them that allow a person to apply pressure to the trigger point. One example is illustrated in Brodsky, U.S. Pat. App. No. 20130085426 A1 of Apr. 4, 2013 and incorporated herein by reference. Brodsky provides a sleeve with 2 rollers with a handle on each end that a user can pull while applying pressure to the trigger point. The user must pull the straps with their hands to achieve pressure.

Citrin, U.S. Pat. App. No. 20110071446 A1 of Mar. 24, 2011, incorporated herein for reference, describes a ball penetrated through two holes used to apply pressure on a trigger point.

One problem with these devices known in the art is that although they provide pressure to trigger points through rollers or balls, they don't allow the user to generate pressure without pulling the ends with their hands. By using the hands, the user's upper body becomes tense with the more pull or push provided by the hands. With the hands preoccupied, a user is unable to put the area with the trigger points through active stretches, preventing the goal of myofascial release.

Current trigger point devices either allow a person to target trigger points through their body weight, or by using the hands to push and pull the device. This does not allow for the ability to apply various degrees of pressure and/or increases tension in the upper body while applying pressure, and/or does not allow for a stretch of the affected area because the hands are preoccupied with the device.

Therefore, a need exists for trigger point therapy devices that are able to provide myofascial release without requiring the time and expense associated with health practitioners. There is a further need for trigger point therapy devices that do not limit the ability to relax the upper body and prevent a person with tender fascial areas to initiate a gentle stretch by requiring the device to be manipulated by the hands. A further need exists for trigger point therapy devices that allow for a gradual increase and decrease in trigger point pressure without requiring the use of the arms or hands to provide this pressure. Finally, there exists a need for a trigger point therapy devices that allow for the application of gradual pressure, free up the hands so there is no tension in the upper body, and allow the hands free to be able to stretch the muscles while pressure is applied.

### BRIEF SUMMARY OF THE INVENTION

It is one object of the present invention to provide a novel trigger point therapy device that is able to provide myofascial release in a self-directed manner.

Another object of the present invention is to provide a novel trigger point therapy device that does not limit the ability to relax the upper body and prevent a person with tender fascial areas to initiate a gentle stretch by requiring the device to be manipulated by the hands.

A further object of the present invention is to provide a novel trigger point therapy device that allows for a gradual increase and decrease in trigger point pressure without requiring the use of the arms or hands to provide this pressure.

An additional object of the present invention is to provide a novel trigger point therapy device that allows for the application of gradual pressure, frees up the hands so there is no tension in the upper body, and allows the hands free to be able to stretch the muscles while pressure is applied.

In preferred embodiments, the apparatus comprises: a flexible strap; a first knob mounted to the strap and protruding out from a side of the strap; a second knob mounted proximate to the first knob and protruding out from the side of the strap in the same direction as the first knob; and a strap adjustment means; and wherein the device is configured so that a user may apply varying degrees of pressure to tight and painful myofascial fascia providing hands free self massage.

In accordance with the present invention, the trigger point therapy device is an effective pain management system based on the treatment of trigger points, releasing tight and painful myofascial fascia, and general self massage. The device works by providing the user with a strap that comprises, in some embodiments, four knobs. The knobs are configured to contact and deliver pressure to target trigger points and/or myofascial fascia. The strap is circular in shape and may be adjustable in length. Portions of the strap may be placed around another body part, another person, or fixed to an external object, while portions of the strap comprising the knobs may be placed in contact with target trigger points and/or myofascial fascia. A user may apply pressure to the trigger point by leveraging other body parts in contact with portions of the strap away from the body or an object, thereby causing the knobs to tighten against the body until the desired pressure is achieved, while keeping the hands free from the device and without tension.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts a perspective view of an example of a trigger point therapy device according to various embodiments described herein.

FIG. 2 illustrates an exploded perspective view of a portion of a trigger point therapy device comprising knobs according to various embodiments described herein.

FIG. 3 shows an exemplary use of a trigger point therapy device according to various embodiments described herein.

FIG. 4 depicts an exemplary use of a trigger point therapy device according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

New trigger point therapy devices and methods are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

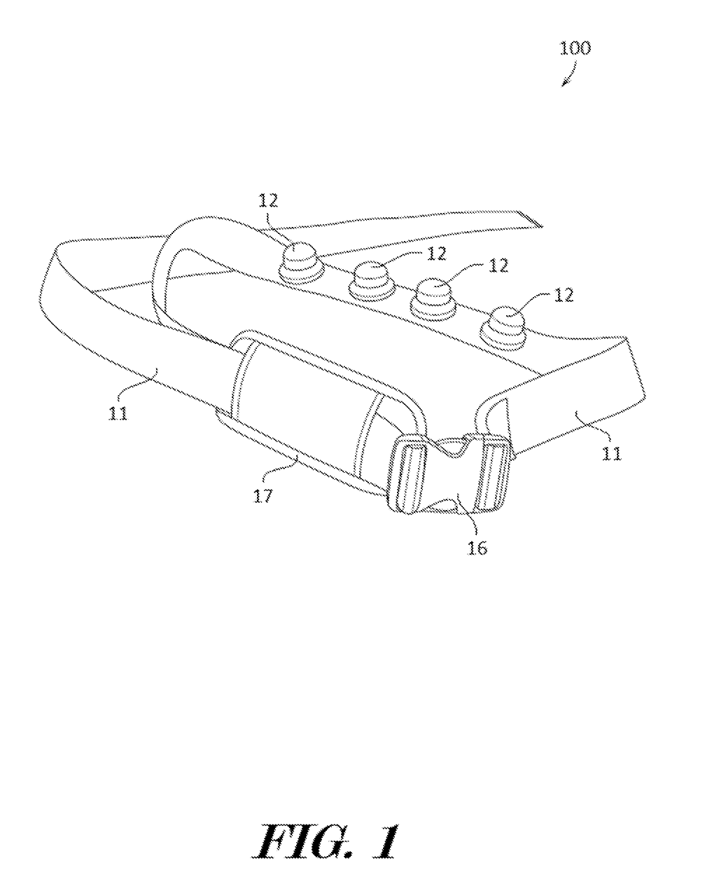

The present invention will now be described by example and through referencing the appended figures representing preferred and alternative embodiments. FIG. 1 illustrates an example of a trigger point therapy device (“the device”) 100 according to various embodiments. In this example, the device 100 comprises a flexible strap 11 configured in a circular or ring shape forming a continuous loop. In this and preferred embodiments, the strap 11 comprises four knobs 12. The strap 11 may also comprise an optional strap adjustment means 16, and an optional strap pad 17.

The device 100 provides an effective and easy to use method in applying pressure to trigger points in all areas of the body. The device 100 is designed to leverage different parts of a user's body to help provide various degrees of tension to trigger points. In preferred embodiments, the device 100 comprises of a plurality of knobs 12 that can be placed over trigger points on desired parts of the body. The user can then place another body part, such as, but not limited to, the forearm, shoulder, elbow, knee, knees, foot, or feet, or an object such as a door, chair, or table against the strap 11 and/or a strap pad 17. The user can adjust the length of the strap 11 with the strap adjustment means 16 so that the strap 11 can be placed at a desired distance from the body. The user can then push, pull, or move in various directions their body parts that are pressing against the knobs 12, the strap 11, and/or a strap pad 17. This allows the user the ability to increase or decrease the amount of pressure that is being delivered to trigger points via one or more knobs 12.

In preferred embodiments, the strap 11 may be approximately 96 inches in length. In other embodiments, the strap 11 can be shorter or longer, depending on the size of the individual. In other embodiments, the strap 11 may comprise a circular shape which may be between twelve and 128 inches in circumference.

Also in preferred embodiments, the strap 11 may comprise a strap adjustment means 16, such as the side release buckle depicted in FIG. 1, which allows the circumference of the strap 11 to be increased or decreased, and allows two ends of the strap 11 to be disconnected from each other to enable the strap 11 to assume a linear shape. In other embodiments, two ends of the strap 11 may not be disconnected from each other to enable the strap 11 to assume a linear shape. In further embodiments, the strap 11 may comprise or be connected to one or more strap adjustment means 16 including but not limited to side release buckles, buckles, clasps, slides, loops, reducers, cam buckles, strap adjusters, snap hooks, D rings, tri-loops, footman loops, keepers, cord locks, strap locks, or any other suitable means for adjusting the length of the strap 11.

Preferably, the strap 11 may be made from Polypropylene webbing. In other embodiments, the strap 11 may be made of other materials, such as but not limited to, synthetic webbing such as nylon webbing, polyester webbing, velour, any elastic material, non-elastic material, woven material, fabric or cloth material, natural webbing such as cotton webbing, other non-fabric flexible materials such as silicone, rubber, plastics, or any other suitable strap type or rope type of material.

In the current embodiment, the strap 11 comprises a strap pad 17 which may be moveable along the length of the strap 11. The strap pad 17 may be configured to slide over the strap 11, allowing a user to distribute the pressure of the strap 11 over any body part. In alternate embodiments, the size of the strap pad 17 can vary depending on the size of the person using the device 100. For example, the strap 11 may comprise a larger sized strap pad 17 to accommodate a larger person. In another example, a strap 11 may comprise a larger strap pad 17 and a smaller strap pad 17. The strap pad 17 may be made from neoprene, plastic, rubber, silicone, nylon, or any suitable soft flexible material.

The present invention lends itself to a method of using the one or more knobs 12 to deliver pressure to points on the body to alleviate pain from trigger points, allow for self myofascial release, or for self massage. Although the figures and discussion of some embodiments of the present invention comprise four knobs 12, those skilled in the art will recognize that in other method and device embodiments disclosed herein may be configured to provide relief to some people by a device 100 that may comprise one, two, or three knobs 12. In further embodiments, methods and devices disclosed herein could provide relief to some people by a device 100 that may comprise five, six, seven, or more knobs 12. In preferred embodiments, the device 100 may comprise more than two knobs 12 but less than ten knobs 12. In even further embodiments, the device 100 may comprise eleven, twelve, thirteen, fourteen, fifteen, or more knobs 12.

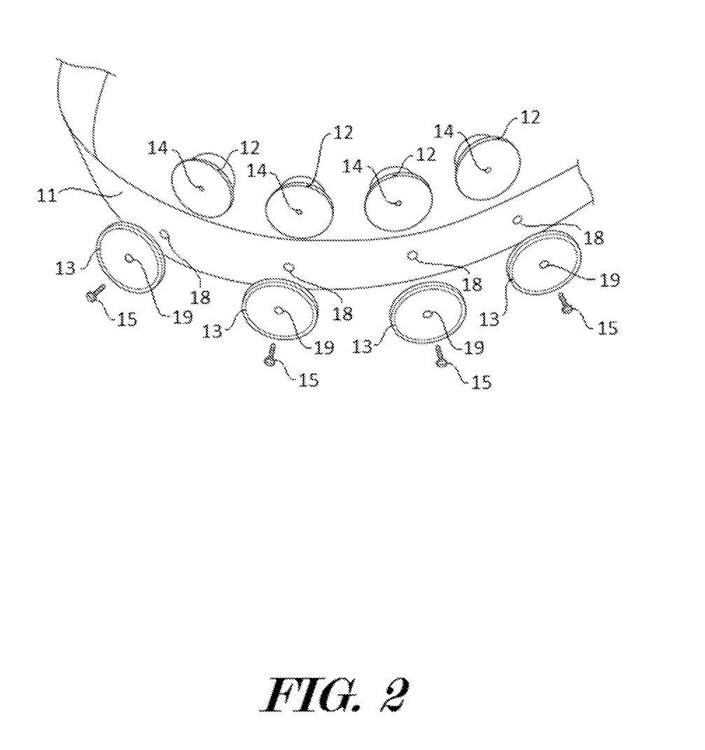

FIG. 2 illustrates an exploded perspective view of a portion of a trigger point therapy device 100 (FIG. 1) comprising knobs 12 according to various embodiments described herein. One or more of the knobs 12 may vary in size and may additionally be interchangeable and removable. Larger knobs 12 may be used for bigger body parts or trigger points, while smaller knobs 12 may be used to target smaller muscle areas or trigger points. The knobs 12 can be spaced together next to each other, or further apart depending on the body area that needs to be targeted. In alternative embodiments, one or more knobs 12 may protrude or extend away from one or both sides of the strap 11.

It should be understood to one of ordinary skill in the art that the knobs 12 may be configured in plurality of shapes including a rounded cylinder shape as depicted, cone shaped, circular shaped, square shaped, rectangular shaped, cylinder shaped, cuboid shaped, hexagonal prism shaped, triangular prism shaped, or any other geometric or non-geometric shape. It is not intended herein to mention all the possible alternatives, equivalent forms or ramifications of the invention. It is understood that the terms and proposed shapes used herein are merely descriptive, rather than limiting, and that various changes may be made without departing from the spirit or scope of the invention.

In some embodiments, one or more of the knobs 12 may comprise temperature adjusting properties. Various cooling means common in the art such as Peltier chips, micro-refrigeration coils, freezer cool packs, chemical cool packs, cold stone panels, or any other temperature reducing method may be used to cool the temperature of a knob 12. Additionally, various heating means common in the art such as electric heating elements, hot stone panels, heat packs, chemical heat packs, or any other temperature increasing method may be used to heat the temperature of a knob 12.

In other embodiments, one or more knobs 12 may be configured to vibrate and/or provide electrical stimulation to areas of the body that it may contact. A knob 12 may be made from steel alloys, aluminum, aluminum alloys, copper alloys, any other type of metal or metal alloy, any type of ceramics, earthenware, natural stone, synthetic stone, various types of hard plastics, hard rubbers, fiberglass, carbon fiber, resins, wood or any other material including combinations of materials that are substantially rigid. A knob 12 may also be made from an elastomer material such as impact absorbing foams, ARTiLAGE artificial cartilage foam, Poron XRD foam, other ARTiLAGE foams, other Poron foams, silicone foams, rubber foams, plastic foams, or other elastomer materials such as elastic plastics, elastic silicone, elastic rubbers, silicone rubbers, or any other suitable substantially flexible material or combinations of materials.

In this embodiment, each knob 12 may be connected to the strap 11 by a fastener 15 which may pass through a strap aperture 18 on the strap 11 and into a fastener aperture 14 on a knob 12. In some embodiments, a fastener 15 may be a threaded type fastener such as a screw or bolt, a clasp type fastener, a clip type fastener, a rivet type fastener, a Velcro® type fastener, a push-to-lock type connection method, a turn-to-lock type connection method, a slide-to-lock type connection method, or any other type of fastener joining method that is capable of temporarily joining a knob 12 to the strap 11 as one reasonably skilled in the art could envision to serve the same function.

In some embodiments, a retainer 13 comprising a retainer aperture 19 may be placed on the opposite side of the strap 11 opposite a knob 12 to prevent the fastener 15 from pulling through the strap 11. In further embodiments, a fastener 15 may be integrally formed or molded together with a fastener 15. In alternative embodiments, two or more fasteners may be used to secure a knob 12 to the strapll. In even further embodiments, two knobs may be fastened together with the strap 11 between the two knobs 12 so that the knobs 12 extend or protrude from both sides of a strap 11.

In preferred embodiments, a fastener 15 may be configured to temporarily secure a knob 12 to any location on the strap 11. Preferably, one or more knobs 12 may be added to or removed from the strap 11 according to user preference. Additionally, one or more fasteners 15 may be configured to pass through one or more strap apertures 18, or they may be configured to pierce the strap 11 and pass through a user desired location on the strap 11 that does not comprise a strap aperture 18.

In other embodiments, one or more knobs 12 may be substantially permanently secured to the flexible strap with heat bonding, chemical bonding, adhesives, rivet type fasteners, stitching, by being integrally molded or formed together, or any other suitable joining method capable of securing substantially permanently joining a knob 12 to the strap 11.

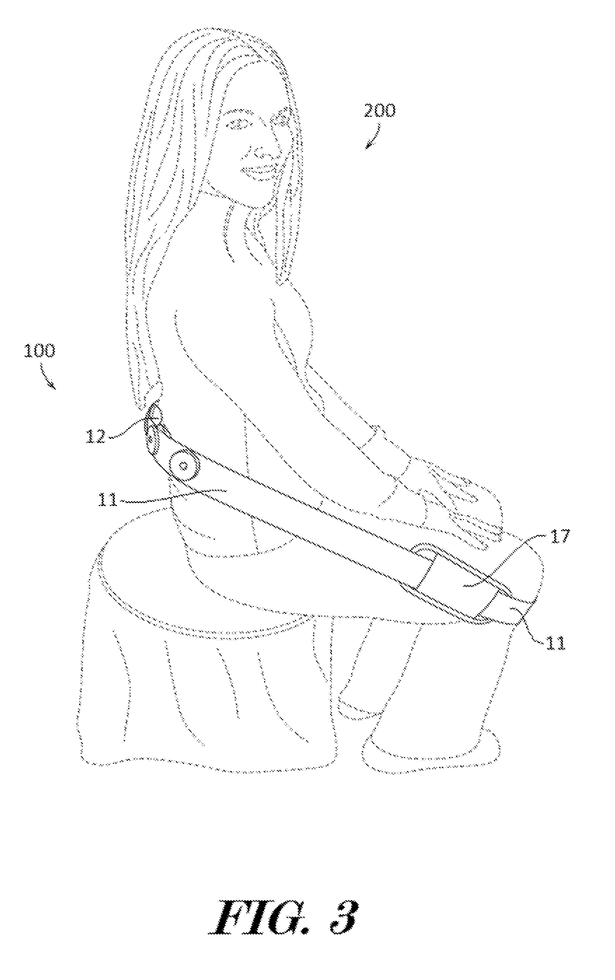

Turning now to FIG. 3, an exemplary use of a trigger point therapy device 100 according to various embodiments described herein. The user 200 may place one or more knobs 12 of a strap 11 in contact with one or more points on the body such as trigger points, myofascial fascial, or any other point or area for self massage. In this example, the user 200 has placed the knobs 12 to generally contact portions of the user's back. The user 200 may then place the strap 11 over one or both knees, and may position the optional strap pad 17 as desired. The user 200 can then push, pull, or move in various directions their body parts that are pressing against the strap 11 and/or a strap pad 17. This allows the user 200 the ability to increase or decrease the amount of pressure that is being delivered to trigger points via one or more knobs 12. By moving their knees closer and further from their torso, a user 200 is able to manipulate the device 100 allowing the knobs 12 to deliver varying amounts of pressure to the desired areas on the body for self actuation of trigger points, self myofascial release, or for self massage so there is no tension in the upper body allowing the hands free to be able to stretch the muscles while pressure is applied.

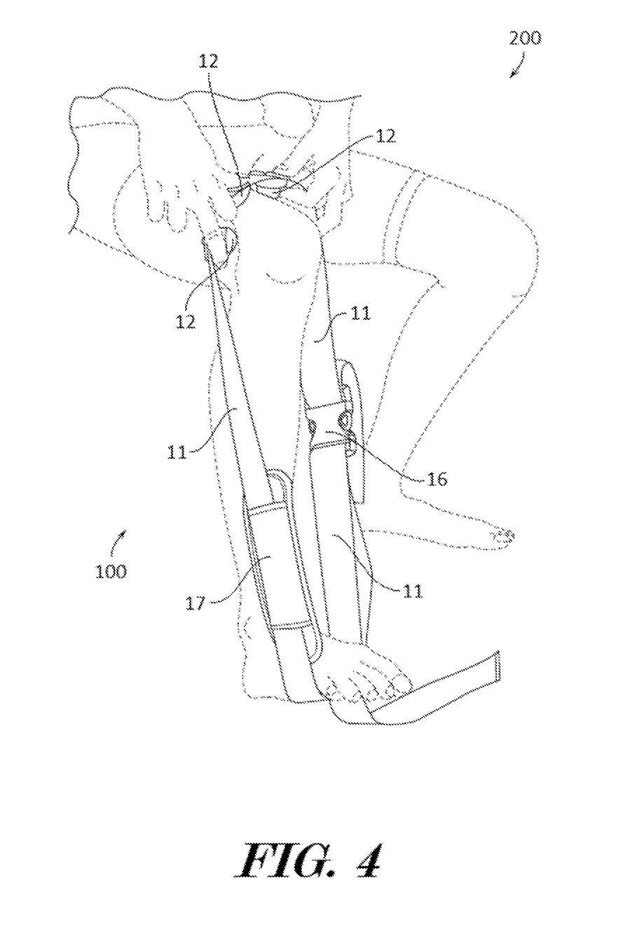

FIG. 4 depicts another exemplary use of a trigger point therapy device 100 according to various embodiments described herein. In this example, the user 200 has placed the knobs 12 to generally contact portions of the user's knee, with portions of the strap 11 are in contact with the user's foot. By moving their foot closer and further from their knee, a user 200 is able to manipulate the device 100 allowing the knobs 12 to deliver varying amounts of pressure to the desired areas on the body for self actuation of trigger points, self myofascial release, or for self massage so there is no tension in the upper body allowing the hands free to be able to further adjust the amount of and location of pressure applied by one or more knobs 12.

In another example, the knobs 12 can be placed on the floor while the user lies down on them. The user may then place the other end of the strap 11, optionally comprising the strap pad 17 over the knee, leg, or foot. The user can now pull on the strap 2 with their knee, leg, or foot allowing for the ability to apply gradual amounts of pressure on the trigger points via the knobs 12.

In an alternative embodiment, a user 200 may attach the flexible strap to an inanimate object such as a door, chair, or table. The user 200 may then place the knobs 12 to generally contact desired areas of the user's body. By moving their body closer and further from the inanimate object, a user 200 is able to manipulate the device 100 allowing the knobs 12 to deliver varying amounts of pressure to the desired areas on the body for self actuation of trigger points, self myofascial release, or for self massage so there is no tension in the upper body allowing the hands free to be able to further adjust the amount of and location of pressure applied by one or more knobs 12.

In another example, a first user may employ the help of a second user in assisting them in applying pressure to their trigger points. One or more knobs 12 may be placed over desired areas on the first user's body, while other portions of the strap 11 may be placed around portions of the second user's body parts, utilizing the push or pull of the second user's body to increase or decrease the amount of pressure delivered to the body of the first user.

In a further embodiment, a user may move through a range of active motion while the knobs 12 are pressed against a trigger point. For example, a user may place the knobs 12 over the left shoulder area, while the strap 11 and/or a strap pad 17 may be held in place by the right foot. As adequate tension is provided, the user can move the left shoulder through various ranges of motion while the knobs 12 press into the trigger point. This embodiment takes advantage of the ability to use the device hands free, allowing a user total freedom to move their arms in various ranges of motion.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A trigger point massage device for providing self massage, the device comprising:
a. a strap;
b. a first knob mounted to the strap and protruding out from a side of the strap;
c. a second knob mounted proximate to the first knob and protruding out from the side of the strap in the same direction as the first knob;
d. a strap adjustment means; and
wherein the device is configured so that a user may apply varying degrees of pressure to tight and painful myofascial fascia providing hands free self massage.

2. The device of claim 1 wherein the strap is a flexible strap configured to bend around the back, lower torso, or other portions of the human body.

3. The device of claim 1 wherein the strap further comprises a strap pad.

4. The device of claim 3 wherein the strap pad is slidably engaged with the strap.

5. The device of claim 4, further comprising a third knob mounted proximate to the second knob and protruding out from the side of the strap in the same direction as the first and second knobs.

6. The device of claim 5, further comprising a knob retainer wherein the retainer comprises a fastener aperture configured to receive a fastener configured to secure a knob and a retainer to the strap.

7. The device of claim 6, wherein the fastener is configured to temporarily secure a knob to the strap.

8. The device of claim 7, wherein the fastener is configured to temporarily secure a knob and a retainer to the strap anywhere along the length of the strap.

9. The device of claim 8, further comprising a fourth knob mounted proximate to the third knob and protruding out from the side of the strap in the same direction as the first, second, and third knobs.

10. A method of self applying varying degrees of pressure to points on the body using a strap-mounted massaging device, said device comprising:
a. a flexible strap configured to form a continuous loop;
b. a plurality of knobs spaced apart along the length of said strap, each knob extending transverse to said strap and being retained thereon;
c. said method of applying pressure to points on the body comprising the steps of:
i. placing the strap over a desired portion of the body with a knob contacting a desired point on the body;
ii. placing portions of the strap over a different portion of the body or an object;
iii. extending the strap away from the body until a knob exerts the desired pressure onto a desired point on the body.

11. The device of claim 10, further comprising a plurality of disc-shaped retainers, each having a fastener aperture configured to receive a fastener, wherein the fastener is configured to secure a knob and retainer to the strap.
